(19) United States
(12) Patent Application Publication
(10) Pub. No.: US 2013/0118329 A1
(43) Pub. Date: May 16, 2013

(54) System for Destruction of Media Discs

(71) Applicant: Edward A. Traylor, SR., Scottsboro, AL (US)

(72) Inventor: Edward A. Traylor, SR., Scottsboro, AL (US)

(21) Appl. No.: 13/296,847

(22) Filed: Nov. 15, 2011

(51) Int. Cl. B26D 7/06

(52) U.S. Cl. 83/409

(57) ABSTRACT

A system for the destruction of media discs includes a box-shaped carrier, dimensioned to receive at least one stack of media discs, with two opposing end walls in each of which is defined at least one slot such that each slot aligns with a corresponding slot in the opposite end wall forming at least one lane where the stack of media discs is disposed within the carrier aligned with the lane. The system also includes a saw table configured to receive the carrier and one least one rotating saw blade mounted above the saw table and aligned with the lane of said carrier.

### BRIEF DESCRIPTION OF THE DRAWINGS

The present invention is described with reference to the accompanying drawings. In the drawings, like reference numbers indicate identical or functionally similar elements.

FIGS. 1A through 1B are various perspective illustrations of an exemplary carrier for use in one embodiment of the present invention;

FIGS. 2, 2A, 2B are various illustrations of an exemplary saw table for use in an embodiment of the present invention;

FIGS. 3A-3C illustrate another exemplary carrier according to another embodiment of the present system;

FIGS. 3D & 3E illustrate an exemplary spindle for use with the carrier depicted in FIGS. 3A through 3C; and

FIG. 4 illustrates the carrier of 3A upon a saw table.

### DETAILED DESCRIPTION

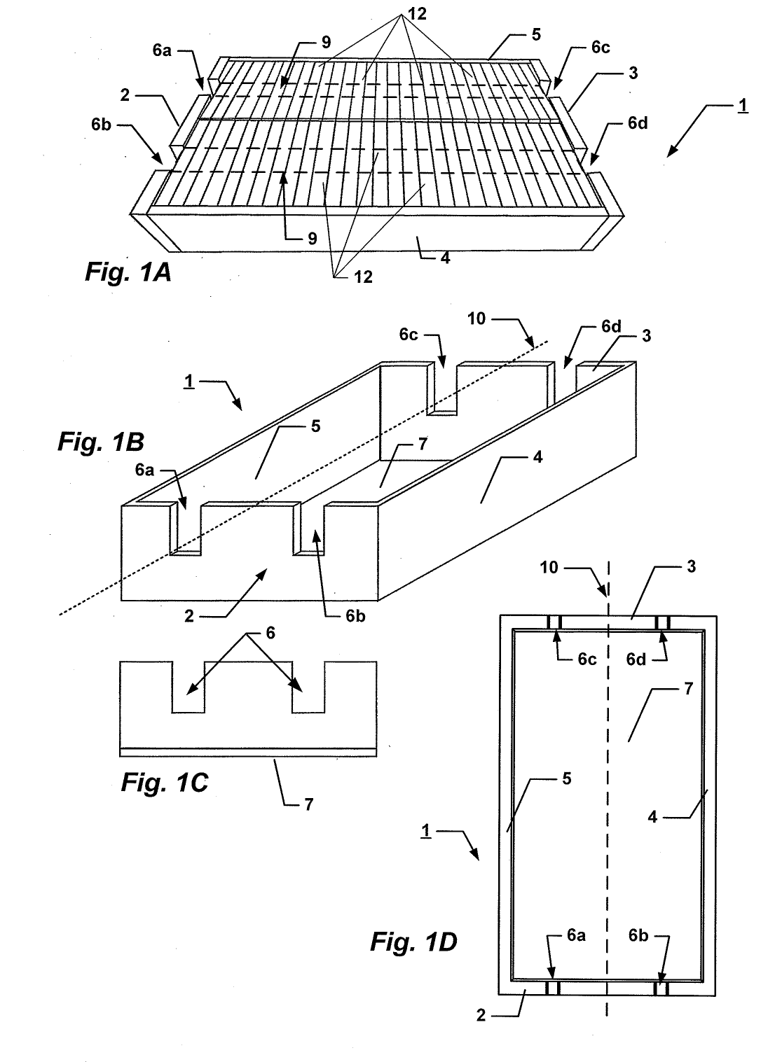

The various embodiments of the present invention and their advantages are best understood by referring to FIGS. 1 through 4 of the drawings. The elements of the drawings are not necessarily to scale, emphasis instead being placed upon clearly illustrating the principles of the invention. Throughout the drawings, like numerals are used for like and corresponding parts of the various drawings.

This invention may be provided in other specific forms and embodiments without departing from the essential characteristics as described herein. The embodiments described above are to be considered in all aspects as illustrative only and not restrictive in any manner. The following claims rather than the foregoing description indicate the scope of the invention.

FIG. 1 illustrates an exemplary carrier 1 for use with the disclosed apparatus. The carrier 1 is a generally box-shaped container having a long axis 10, two end walls 2, 3, and two lateral walls 4, 5, and a bottom 7. At least one slot 6a-d is defined in each end wall 2, 3 such that a slot 6a in one end wall 2, will align with a slot 6c in the opposite end wall 3. FIGS. 1A-1D show two sets of slots aligned in parallel. As such, slot 6c in end wall 2 aligns with slot 6d in end wall 3. It can be seen that the alignment of the opposing slots 6 form lanes 9 running parallel to the longitudinal axis 10. More slots 6 may be added to form more lanes 9 if desired.

As shown in FIG. 1A, carrier 1 is dimensioned to receive and hold a plurality of media discs in cases 12 stacked in alignment, again parallel to the long axis 10. The carrier 1 shown in the figure illustrates an embodiment having two slots on either end, and thus, two stacks of media disc cases 12 are retained within the carrier 1, each stack aligned along the channel 9 formed by corresponding end slots 6. Carrier 1 may be adapted to hold more stacks of media disc cases. It should be understood that the media disc cases contain discs.

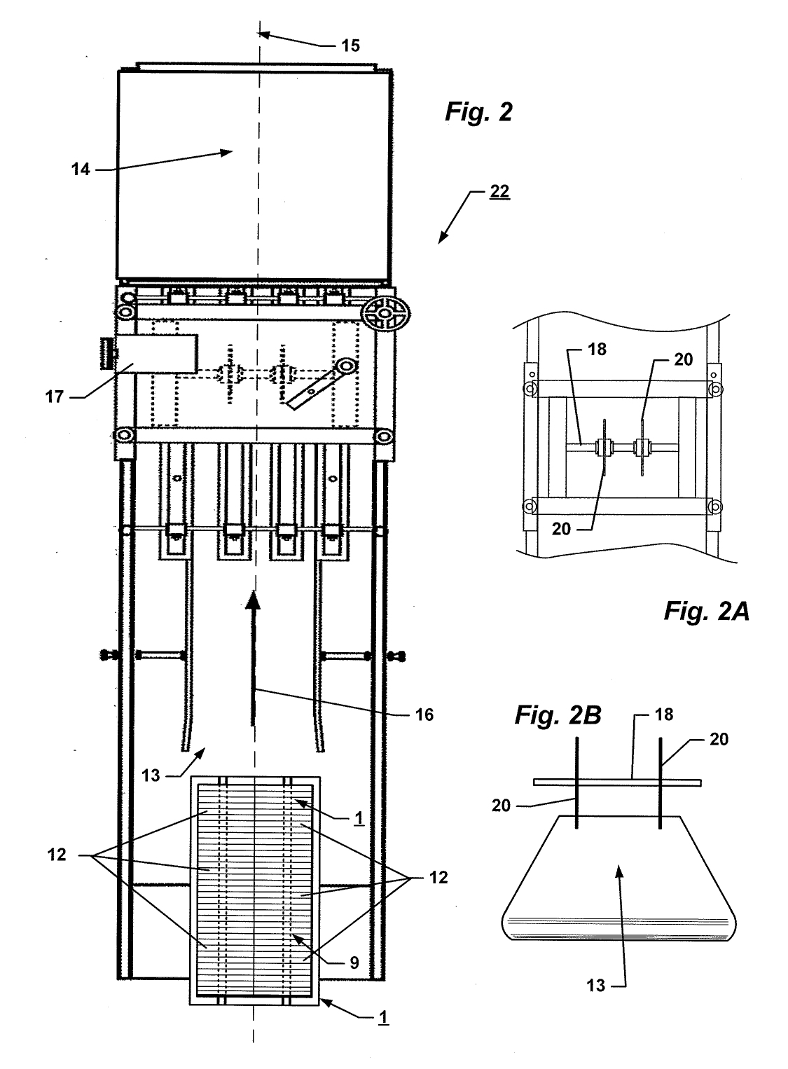

The system includes a saw table 22 having a feed end 13 and an output end 14 and a longitudinal axis 15 parallel to the direction of feed (indicated by reference arrow 16). At least one rotating saw blade 20 (FIG. 2A) is mounted on a rotating axle 18 over the surface of the conveyor parallel to the longitudinal axis 15 and the direction of feed 16, and is coupled to a motor 17 which rotates the axle 18, and thus, the saw blade 20. The table 22 may comprise a conveyor apparatus (e.g., a belt) for conveying material from the feed end 13, through the saw blades 20, and to the output end 15. The axle 18 and saw blade 20 is mounted at a height above the surface of the table. The number of saw blades 20 corresponds to the number of lanes 9 with which the carrier 1 is configured.

In operation, the carrier 1 is packed with one or more stacks of media disc cases 12 inserted into the carrier 1 perpendicular to the longitudinal axis. The carrier 1 is placed upon the input end 13 of the table 22 where the first and second slots are in line with the saw. The carrier is drawn through the table 22 and the saw blades 20 are allowed to pass through the end slots 6 and along the lanes 9, thereby cutting a slot in all of the media disc cases, and the discs, retained in the carrier.

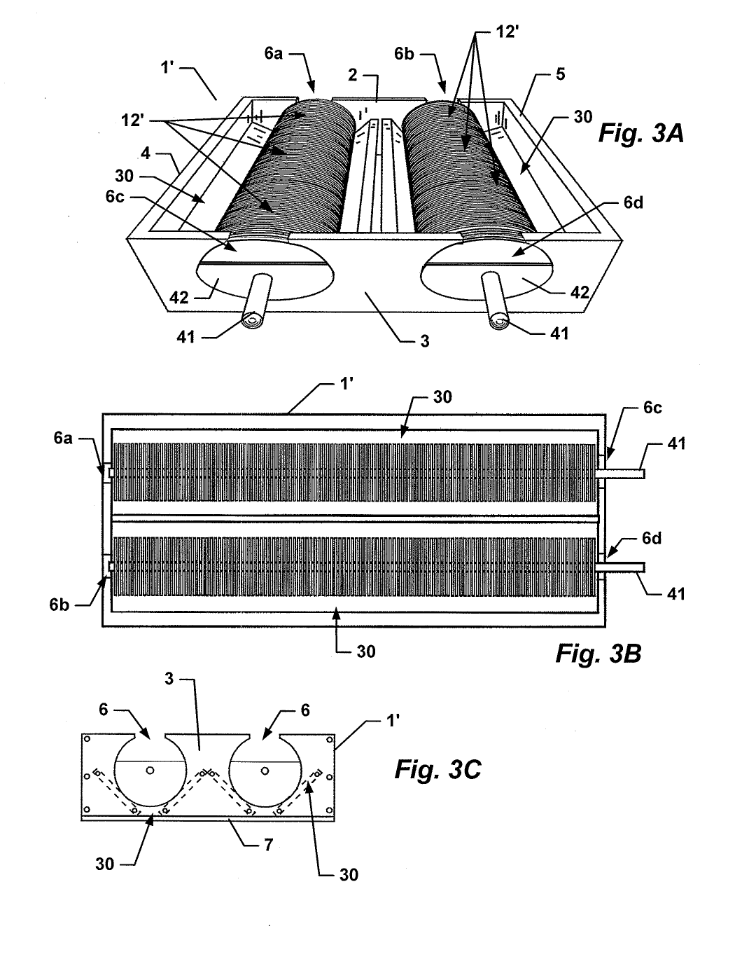

An alternative carrier assembly 1′ is shown in FIGS. 3A-E which is adapted to facilitate the cutting of multiple discs 12′, such as a media disc that is configured with a hole in its center. The carrier 1′ again is configured similarly to that described above with end walls 2, 3, lateral walls 4, 5 and a floor 7. Likewise, carrier 1′ is configured with end slots 6a-6d. In this embodiment, the carrier 1′ is configured with one or more longitudinal channels 30 each defining a longitudinal axis aligned with the end slots 6. Channels 30 have a transverse dimension sufficient to accommodate an arc of a disc 12′ placed on its edge and perpendicularly within the channel as shown in the figures, and to prevent lateral movement of discs 12′ placed therein.

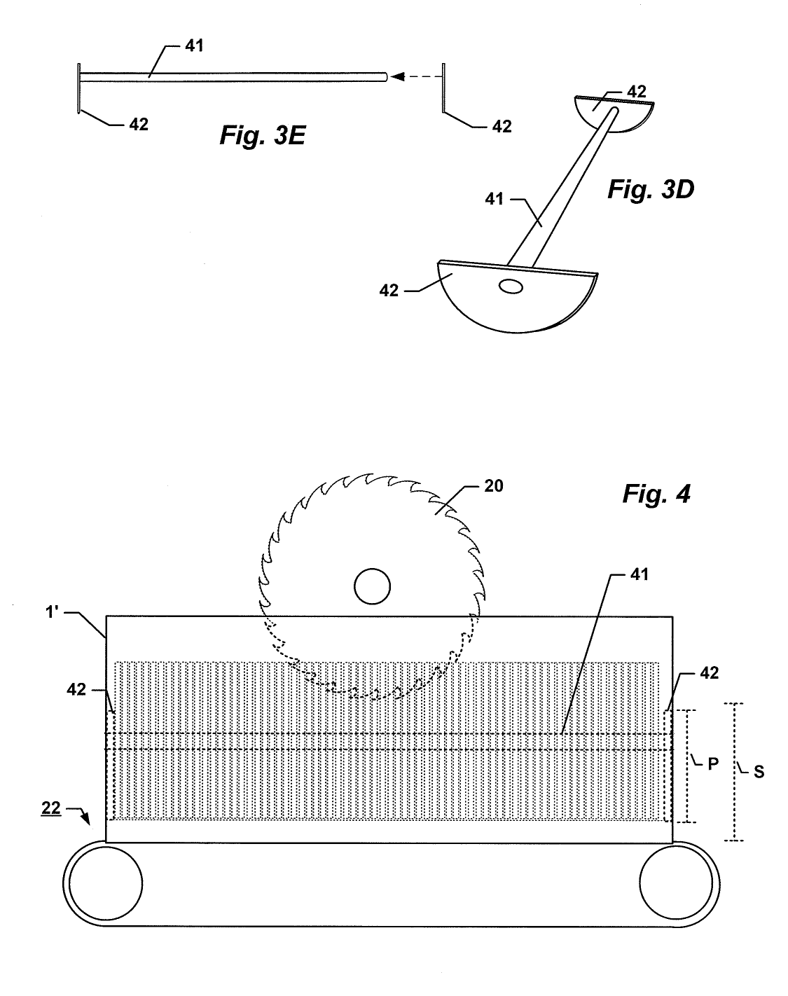

As shown in FIG. 3C, a channel may be formed by installing a pair of longitudinal members, each declined toward each other. Discs are preferably placed onto a spindle 41 inserted through the center hole. The discs are stacked against an end plate 42a, b mounted to either end of the spindle 41. The end plate 42 can be of any shape as long no part of the plate interferes with the depth of the cut. In other words, as shown in FIG. 4, the height of the top edge of the plate P must be less than the height of the saw blade above the table S. As such, when the carrier 1′ is drawn through the saw table, the saw blade 20 cuts the discs 12′ to a depth coincident with the height of the blade above the table, but does not touch the end plate 42.

As described above and shown in the associated drawings, the present invention comprises an apparatus for a system for destruction of media discs. While particular embodiments of the invention have been described, it will be understood, however, that the invention is not limited thereto, since modifications may be made by those skilled in the art, particularly in light of the foregoing teachings. It is, therefore, contemplated by the appended claims to cover any such modifications that incorporate those features or those improvements that embody the spirit and scope of the present invention.

What is claimed is:

1. A system for the destruction of media discs:
a box-shaped carrier having a longitudinal axis, two opposing end walls perpendicular to said axis, and at least one slot defined in each said end wall such that a first slot in one end wall will align with a second slot in the opposite end wall forming at least one lane running parallel to the longitudinal axis, said carrier dimensioned to retain at least one stack of a plurality of media discs, said stack disposed within said carrier aligned with said lane;
a saw table configured to receive said carrier at an input end and convey said carrier to an output end in a direction of movement congruent with said longitudinal axis of said carrier;
one least one rotating saw blade mounted above said saw table at a height and aligned with said at least one lane of said carrier, said height being such that a depth of cut in said stack of media discs is achieved as said carrier is conveyed from said input end to said output end.

2. The system of claim 1, wherein said at least one slot in each said end wall is at least two slots in each said end wall wherein each said slot in one end wall is aligned with a corresponding slot in said opposing end wall forming at least two lanes, and wherein said at least one saw rotating saw blade is at least two rotating saw blades, each said saw blade aligned with one of said lanes.

3. The system of claim 2, wherein the carrier is dimensioned to retain at least two stacks of media discs, each said stack aligned with each said lane.

4. The system of claim 3, wherein each said disc is retained within a disc case.

5. The system of claim 1, further comprising at least one spindle for supporting said at least one stack of discs.

6. The system of claim 5, further comprising first and second end plates removably attached to first and second ends of said spindle, said end plates shaped such that a top edge thereof is at a height above said saw table less than the height of said at least one saw blade.

7. The system of claim 6, wherein said at least one slot in each said end wall is at least two slots in each said end wall wherein each said slot in one end wall is aligned with a corresponding slot in said opposing end wall forming at least two lanes, and wherein said at least one saw rotating saw blade is at least two rotating saw blades, each said saw blade aligned with one of said lanes.

8. The system of claim 7, wherein the carrier is dimensioned to retain at least two stacks of media discs, each said stack aligned with each said lane.

9. A box-shaped carrier for holding media discs and carrying said discs through a saw table having at least one rotating saw blade, said carrier comprising:
a longitudinal axis;
two opposing end walls perpendicular to said axis; and
at least one slot defined in each said end wall such that a first slot in one end wall will align with a second slot in the opposite end wall forming at least one lane running parallel to the longitudinal axis; and
wherein said stack is disposed within said carrier aligned with said lane and said lane is aligned with said rotating saw blade.

10. The carrier of claim 9, wherein each said disc is retained within a disc case.

11. The carrier of claim 10, further comprising at least one spindle for supporting said at least one stack of discs.

12. The carrier of claim 11, further comprising first and second end plates removably attached to first and second ends of said spindle, said end plates shaped such that a top edge thereof is at a height above said saw table less than the height of said at least one saw blade.

13. The carrier of claim 12, wherein said at least one slot in each said end wall is at least two slots in each said end wall wherein each said slot in one end wall is aligned with a corresponding slot in said opposing end wall forming at least two lanes, and wherein said at least one saw rotating saw blade is at least two rotating saw blades, each said saw blade aligned with one of said lanes.

14. The carrier of claim 13, wherein the carrier is dimensioned to retain at least two stacks of media discs, each said stack aligned with each said lane.
